(19) United States
(12) Patent Application Publication
(10) Pub. No.: US 2007/0162845 A1
(43) Pub. Date: Jul. 12, 2007

(54) User interface for webpage creation/editing

(75) Inventors: Richard Cave, Camas, WA (US); Christopher Rudolph, Camas, WA (US); Roger Rosner, Mountain View, CA (US); Jay Capela, Santa Cruz, CA (US)

Correspondence Address: VAN PELT, YI & JAMES LLP AND APPLE COMPUTER, INC., 10050 N. FOOTHILL BOULEVARD, SUITE 200, CUPERTINO, CA, 95014, US

(73) Assignee: Apple Computer, Inc.

(21) Appl. No.: 11/328,956

(22) Filed: Jan. 9, 2006

(51) Int. Cl. G06F 17/00; G06F 3/048

(52) U.S. Cl. 715/530; 715/513; 715/526; 715/764

(57) ABSTRACT

Enabling a user to create and/or edit a webpage is disclosed. A selection of a selected template from a set of one or more webpage templates selectable by a user to create and open for editing an instance of a webpage is received. An instance of a webpage based at least in part on the selected template is created. A representation of the webpage that shows the webpage as it would appear as published is displayed in an editing interface. The representation of the webpage is updated in real time in response to changes, if any, made to the webpage, so that as changes, if any, are made to the webpage the representation is updated to show the webpage as it would appear as published with the changes incorporated.

### BACKGROUND OF THE INVENTION

Increasingly individuals, small businesses, and others not typically able to retain the services of professional website designers and/or high end website creation software desire to make information available to themselves and others via the Internet. Web-based tools and downloadable clients have been provided to enable such users to create websites, however such existing tools typically provide users with only a limited ability to control the content, layout, and styling of their web pages and do not have an intuitive user interface that enables the user to see in real time, while the user is composing the page, how the page will appear once published on the Web. Therefore, there is a need for an improved user interface for webpage creation and editing.

### BRIEF DESCRIPTION OF THE DRAWINGS

Various embodiments of the invention are disclosed in the following detailed description and the accompanying drawings.

FIG. 1 is a block diagram illustrating an embodiment of a user interface for creating and/or editing a webpage.

FIG. 2 is a flow chart illustrating an embodiment of a process for enabling a user to create and/or edit a webpage.

FIG. 3 is a flow chart illustrating an embodiment of a process for providing a webpage creation/editing interface.

FIGS. 4A and 4B are block diagrams illustrating an embodiment of a user interface for creating and/or editing a webpage containing photographs or other images or media content.

FIG. 5 is a flow chart illustrating an embodiment of a process for including a photo grid in a webpage.

FIG. 6 is a flow chart illustrating an embodiment of a process for incorporating user content into a photo grid.

FIG. 7 is a block diagram illustrating an embodiment of a user interface for creating/editing a webpage.

FIGS. 8A and 8B are block diagrams illustrating an embodiment of a user interface for creating/editing a blog page.

FIG. 9 is a flow chart illustrating an embodiment of a process for enabling a user to create/edit a blog page.

### DETAILED DESCRIPTION

The invention can be implemented in numerous ways, including as a process, an apparatus, a system, a composition of matter, a computer readable medium such as a computer readable storage medium or a computer network wherein program instructions are sent over optical or electronic communication links. In this specification, these implementations, or any other form that the invention may take, may be referred to as techniques. A component such as a processor or a memory described as being configured to perform a task includes both a general component that is temporarily configured to perform the task at a given time or a specific component that is manufactured to perform the task. In general, the order of the steps of disclosed processes may be altered within the scope of the invention.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

A user interface for webpage creation and editing is disclosed. In some embodiments, the user interface provides in real time a display that shows a webpage that is being created or edited as it will/would appear if/when published to the Web and/or otherwise viewed using a browser or other viewer. Changes are made to the page as displayed, enabling a user to see in real time how changes will affect the page as viewed via the Web. An indication of changes made to the page, such as additional objects added to the page or placeholder or other objects being replaced by user content, is received and the display is to show how the change will affect the appearance of the page as/when published. In some embodiments, the display is provided using a graphics and text rendering environment to which the constraints to which a webpage is subject have been added, so that the rendering environment provides via the user interface only output that can be rendered faithfully when the page is published to the Web. In some embodiments, the user interface presents a selection of templates from which the user can choose a template to be used to add a page to a website currently being created or edited. Selection of a template causes a new page based on that template to be added and displayed for editing. Placeholder text and objects are included in the template to show the user the default layout and styling that would be applied to user content. A user replaces placeholder content in some embodiments by dragging items from folders or other storage locations on the user's client system and dropping them in the location in which the user interface is displaying the placeholder or other current content that the user content is to replace. In some embodiments, as certain pages are added and/or edited changes to those pages are reflected in real time in related pages, such as by generating and/or updating menu or navigation bar entries, links, and/or summaries on such other pages.

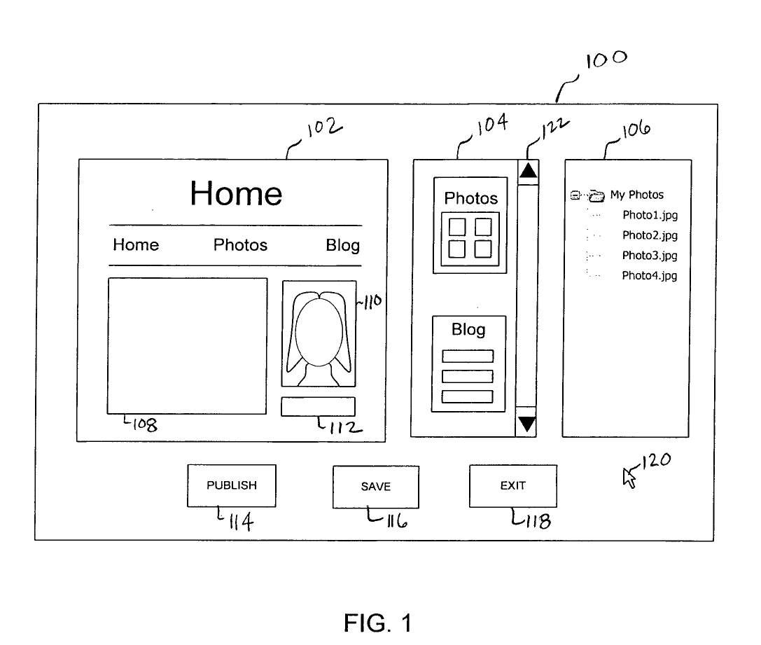

FIG. 1 is a block diagram illustrating an embodiment of a user interface for creating and/or editing a webpage. A user interface 100 includes an editing pane 102, a template pane 104, and a user file navigation pane 106. In some embodiments, the user file navigation pane 106 is not included in user interface 100 and is instead provided by an operating system or other software installed on a client on which the user interface 100 is running. The user file navigation pane 106 enables a user to navigate to user files stored on or otherwise available via the user's client system, such as files stored on a hard drive associated with the client system, on removable or other media currently installed on a drive or port of the client system, and/or on a system and/or storage device or media accessible to the client system via a network.

The user interface 100 also includes a “save” button 116 to save the webpage/project currently being edited, a “publish” button 114 to publish the current project to the Web, and an “exit” button 118 to exit the user interface 100 and close the associated application. A pointer icon 120 responsive to manipulation by a user of a mouse or other user input/control is provided to enable a user to activate controls such buttons 114-118, position a cursor in a text or other area, and/or drag/drop items into editing pane 102, such as a template from template pane 104 or a file or other object from user file navigation pane 106. Selection of the publish button 114 causes an application or module associated with user interface 100 to generate html and/or other code and objects as required to publish the webpage(s) to the Web. In some embodiments, selection of publish button 114 causes an existing or available web access and/or publishing account, such as “.Mac” account provide by Apple Computer, Inc., to be opened and used to publish the webpage(s). In some embodiments, if no such account exists or is known a user is prompted to open an account and/or provide data identifying an account to be used to publish the webpage(s).

In the example shown in FIG. 1, a home page has been selected for creation or editing. A home page such as the one displaying in the editing pane 102 as shown in FIG. 1 is opened in various embodiments by opening a previously saved webpage/website project that includes the home page, by selecting “new” from a file or other menu to indicate a desire to start a new webpage/website project, and/or by selecting a homepage template from among one or more homepage templates displayed in template pane 104.

Template pane 104 displays a “thumbnail” size icon for each of a set of one or more templates available to be selected by a user, e.g., by clicking or double-clicking on the desired template and/or dragging and dropping the desired template into editing pane 102, to create and open for editing in editing pane 102 a new webpage. In some embodiments, the templates displayed at any given time in template pane 104 comprise or at a user's option may comprise a subset of a broader set of available templates. In some embodiments additional templates may be obtained, e.g., purchased, via the Internet or otherwise. In some embodiments, the templates displayed in template pane 104 includes a blank template and/or one or more templates that have a background associated with one or more other templates displayed in template pane 104 but no other default/placeholder content. In the example shown, template pane 104 includes a scroll bar 122 to enable a user to view additional templates.

In various embodiments, templates as displayed in template pane 104 and/or as displayed initially in editing pane 102, when selected, include one or more items of placeholder content displayed as it would appear upon being published to the Web. The placeholder content enables a user to see the layout and styling applied to content items on the page. Placeholder text is replaced in some embodiments by selecting the placeholder text in the editing pane 102 and replacing it with user content, e.g., text entered in editing pane 102 using a keyboard or other input device; text cut and pasted from a document, file, clipboard, or other source; and/or text in a file or other object dragged from user file navigation pane 106 to the placeholder as displayed in editing pane 102.

In the example shown in FIG. 1, the home page displayed in editing pane 102 includes a placeholder title “Home” with a website navigation bar underneath the title listing the pages “Home”, “Photos”, and “Blog”. In this example, the project being edited includes three pages, each still having the placeholder title in the title area. In some embodiments, editing the title in any individual page causes the link to that page as listed in the navigation bar to be updated to reflect the user-supplied title. In some embodiments, a user can edit the automatically-generated link by clicking on the associated text in the navigation bar as displayed on any page and entering the desired text. The home page displayed in editing pane 102 as shown in FIG. 1 includes a main text area 108, an image area 110, and an image caption text area 112. In this example, a default image of a person's head is included as a placeholder image in image area 110, enabling a user to see the styling/formatting that would be applied to a user image substituted for the placeholder image. A user image dragged from user file navigation pane 106, e.g., “Photo1.jpg” in the example shown, and dropped in image area 110 in some embodiments causes the placeholder image to be replaced by the user image, with the styling and formatting formerly applied to the placeholder image being applied to the user image automatically, and the user image being displayed, in place of the placeholder image, in image area 110 in real time, automatically and substantially immediately after the user image file is dropped in image area 110, with the same appearance as the image would have as published to the Web.

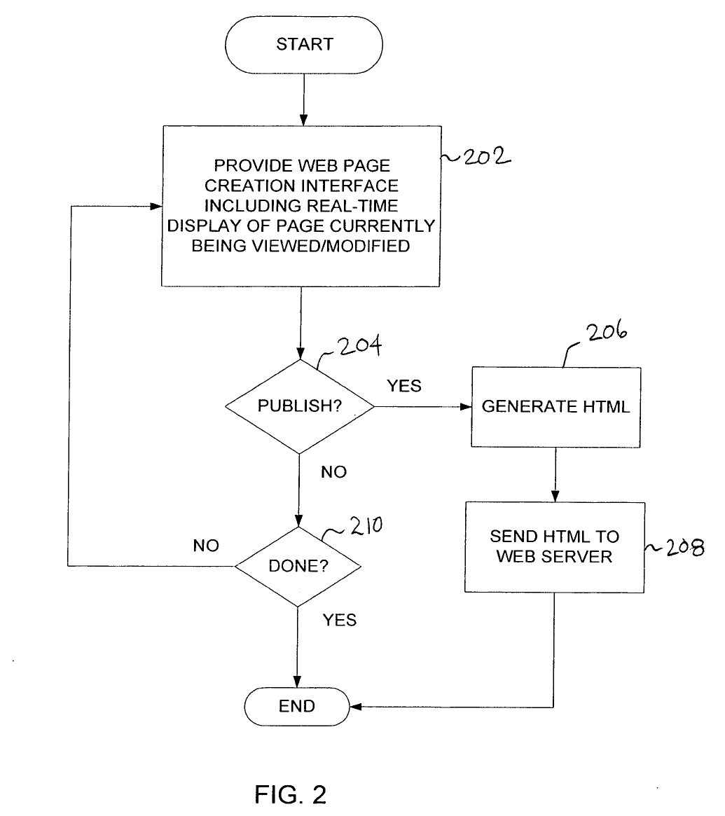

FIG. 2 is a flow chart illustrating an embodiment of a process for enabling a user to create and/or edit a webpage. In the example shown, at 202 a web page creation/editing user interface that provides in real time a display of a webpage that is currently being created, viewed, and/or edited that shows the webpage as it will/would appear when published to the Web. In some embodiments, the user interface 100 of FIG. 1 is provided. At 204, it is determined whether an indication has been received that the webpage and/or a website or project of which it is a component is desired to be published to the Web. If so, at 206 any html or other code or content required to be generated to publish the page (and any other pages comprising the site, if applicable) is generated and in 208 the html and/or other code or content is sent to a web server, after which the process of FIG. 2 ends. In some embodiments, 208 includes opening and accessing an existing, known (e.g., preconfigured), and/or newly opened web access and posting account, such as a .Mac account and providing the html and/or other code or content for publication to the Web. In some embodiments, 208 includes receiving a URL or other address or identifier usable to access the webpage and/or associated site via the Web. If at 204 it is determined that an indication that the webpage is to be published has not been received, it is determined at 210 whether the user has indicated he/she is done editing the current page or project. If so, the user interface is closed and the process of FIG. 2 ends. Otherwise, at 202 the interface remains open and the current page displayed unless/until the page is published and/or the user indicates he/she is done.

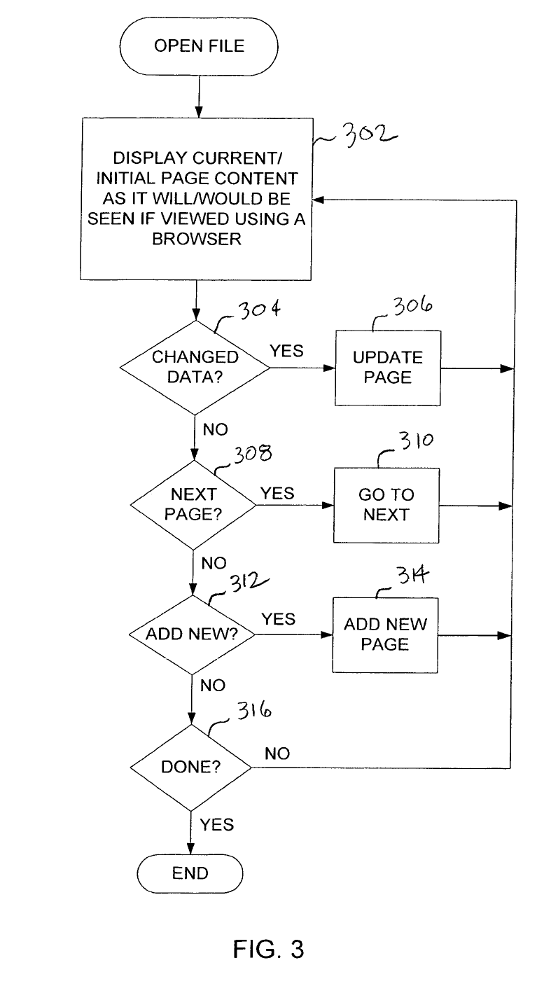

FIG. 3 is a flow chart illustrating an embodiment of a process for providing a webpage creation/editing interface. In some embodiments, 202 of FIG. 2 includes the process of FIG. 3. At 302, a webpage that is currently being created, viewed, and/or edited is displayed, e.g., in an editing pane such as editing pane 102 of FIG. 1, with current and/or initial or default page content with the appearance the page will/would have when/if published to the Web. As content data is added and/or modified (304) the display is updated automatically and in real time to incorporate the changes (306), so that the page as displayed via the user interface always shows the current state of the page as created and/or edited by the user, always having the appearance the page will/would have if/when published. If an indication that a next existing webpage, e.g., another page comprising a website or project with which a webpage currently being displayed is associated, is desired to be displayed and/or edited (308), the next page is accessed and displayed via the user interface (310) and the current page content for that page is displayed via the user interface, and updated as content is added and/or modified, as the user views/edits the page (302-306). If an indication that a new webpage, e.g., a new page to be added to a website or project with which a webpage currently being displayed is associated and/or a new page not related to the current page, is desired to be displayed and/or edited (312), the new page is generated, e.g., based on the selected template, and displayed via the user interface (314) and the current page content for that page is displayed via the user interface, and updated as content is added and/or modified, as the user views/edits the page (302-306). The process of FIG. 3 ends when an indication is received that the user is done creating/editing pages (316).

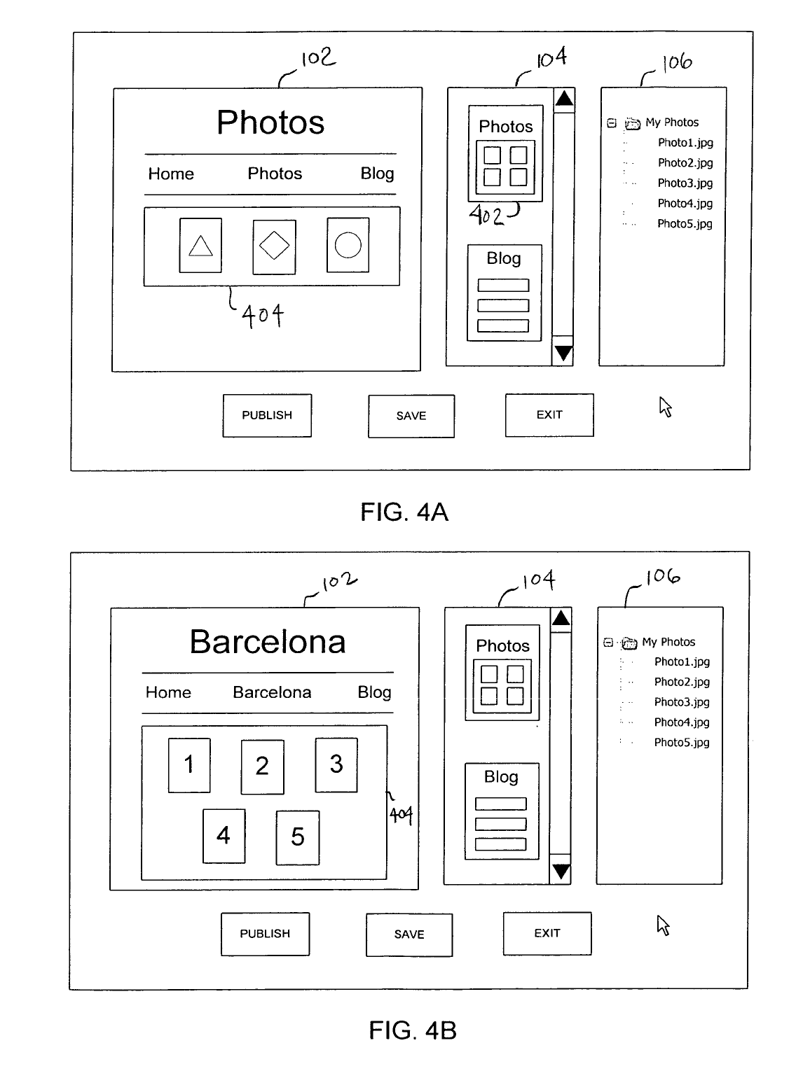

FIGS. 4A and 4B are block diagrams illustrating an embodiment of a user interface for creating and/or editing a webpage containing photographs or other images or media content. In the example shown, in FIG. 4A a webpage entitled “Photos” has been created and is displayed in editing pane 102, e.g., as a result of a user selecting the “Photos” page template 402 in the template pane 104. The page as shown in FIG. 4A includes a photo grid 404 that includes as default content three placeholder images arranged in a single row. In the same page displayed as shown in FIG. 4B, a user has changed the title to “Barcelona”, which in this example has caused the corresponding link on the site navigation bar to change automatically and in real time from “Photos” to “Barcelona”. In addition, in this example as shown in FIG. 4B the user has replaced the three placeholder images with user images “1”, “2”, and “3”, e.g., by successively dragging and dropping files containing these images from user file navigation pane 106 to a destination one of the placeholder images shown originally in photo grid 404 as shown in FIG. 4A. In this example, additional user images “4” and “5” have been added to photo grid 404, e.g. by dragging them from user file navigation pane 106 to the photo grid 404 as displayed in editing pane 102, which in this example has caused the photo grid 404 to be re-sized automatically to accommodate the additional images, which have automatically been arranged in a second row and spaced evenly and centered within the second row. In some embodiments, addition of further images would result in additional rows being added, as needed. In some embodiments, if the photo grid would exceed a prescribed size if expanded further to accommodate additional images, e.g., a size considered too large to be displayed in a single webpage as displayed in a typical viewing device/system, a scroll bar and associated functionality is added automatically to the photo grid 404, both as displayed in editing pane 102 and in the page as published.

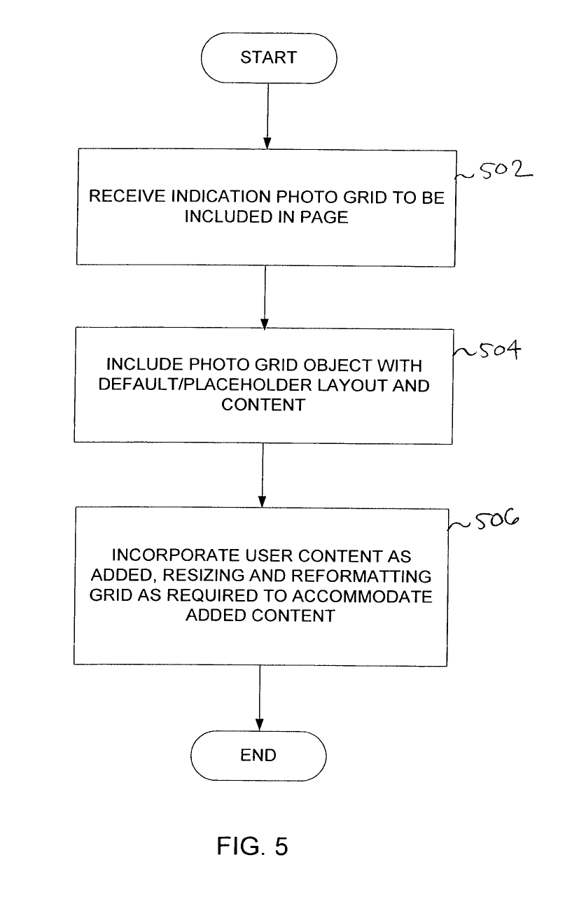

FIG. 5 is a flow chart illustrating an embodiment of a process for including a photo grid in a webpage. At 502, an indication is received that a photo grid is to be included in a webpage. Example of an indication received at 502 include receiving an indication that a template including a photo grid has been selected and receiving an indication that a user has indicated, e.g., via a menu or toolbar selection or otherwise, that a photo grid is desired to be added to a page currently being edited. At 504, a photo grid object with default layout and placeholder content is included in the page as displayed via a user interface, e.g., editing pane 102. The object causes the photo grid and photos currently included therein, initially the default/placeholder images, to be displayed via the user interface as they will/would appear when/if published to the Web; provides an interface for incorporating user images to replace placeholder images and/or as additional images; and ensures images added to the grid are displayed and/or otherwise made accessible via the Web page as published. In some embodiments, the photo grid object is a sub-template that becomes linked or otherwise associated with and integrated into a page template being used to create and edit the page into which the photo grid is being incorporated. At 506, user content, e.g., user images, are incorporated as content is added, and the photo grid is resized and/or reformatted if required to accommodate added user content. In various embodiments, photographs, other still images, graphics, movies, audio clips, and/or other media objects or content items may be added to a photo or other media grid.

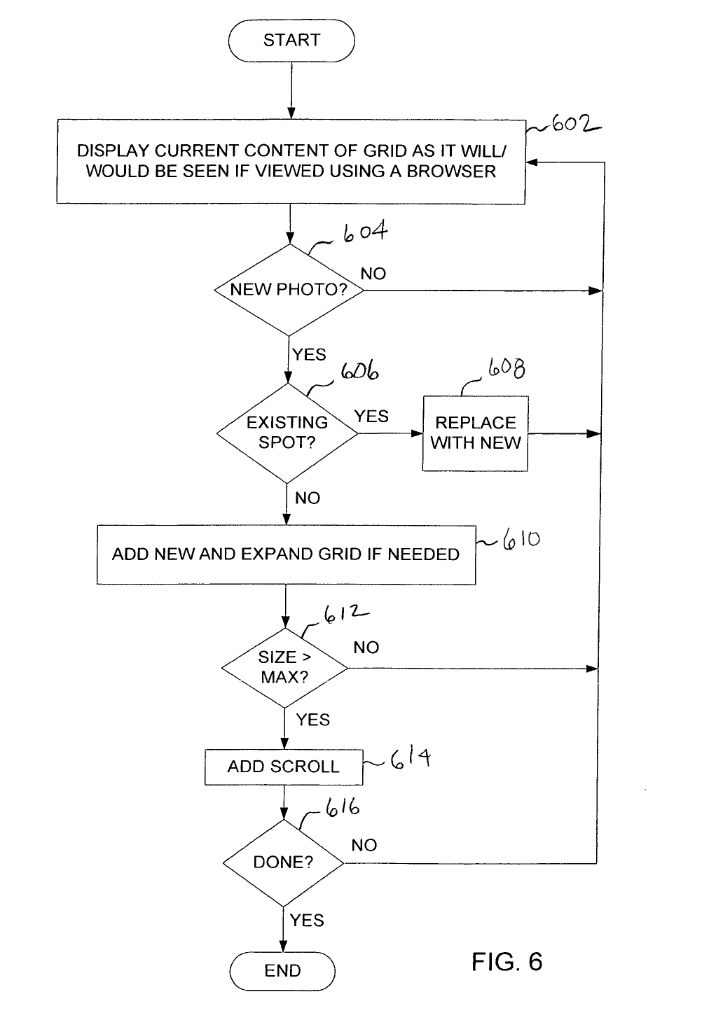

FIG. 6 is a flow chart illustrating an embodiment of a process for incorporating user content into a photo grid. In some embodiments, 506 of FIG. 5 includes the process of FIG. 6. At 602, the current content of the photo grid is displayed via a user interface, e.g., in editing pane 102, in the manner it will/would appear when/if published to the Web. If a new photo or other user image is added (604), e.g., if a .jpg or other image file is dragged and dropped into the photo grid, it is determined at 606 whether the location within the grid where the image was dropped corresponds to an existing image location, e.g., a placeholder image, and if so at 608 the image currently associated with and displayed via the user interface at that location is replaced with the new photo or image. Otherwise, at 610 the new image is added to the grid and the grid is resized and/or reformatted, e.g., by arranging the images in the grid. If adding the new image would otherwise require that the grid size be expanded beyond a prescribed limit (612), at 614 a scroll bar and associated functionality is added to the grid to enable all the images to be arranged within and displayed via the grid without exceeding the grid size limit. Conversely, if one or more images are deleted or otherwise removed from the grid, the grid is resized and reformatted to accommodate the smaller set of images and, if applicable, a scroll bar and associated functionality added previously may be removed if the number of images is reduced to a point where they can all be displayed at once in the grid without exceeding the maximum grid size. The process ends once a user indicates he/she is done editing the page (616).

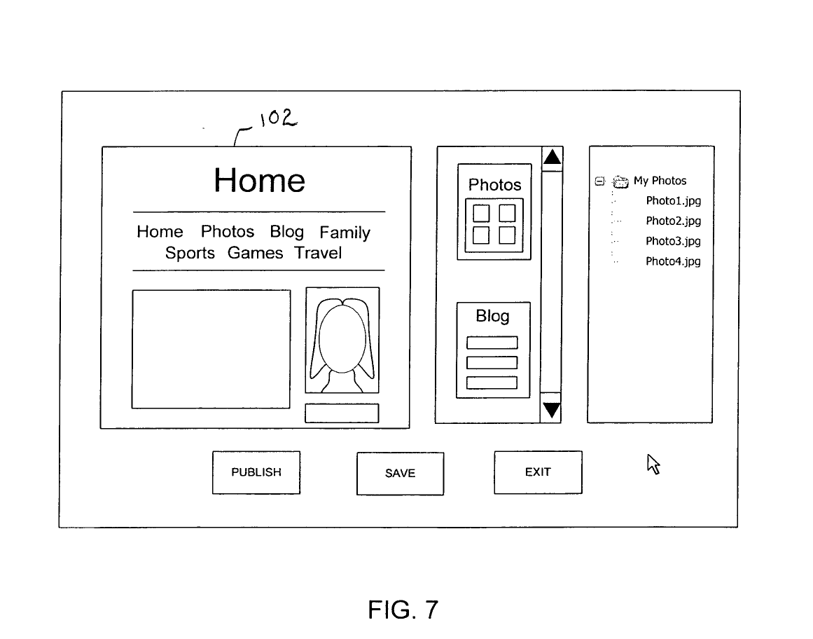

FIG. 7 is a block diagram illustrating an embodiment of a user interface for creating/editing a webpage. In the example shown, the home page shown in FIG. 1 as being displayed in the editing pane 102 is displayed in FIG. 7 in a later state, after additional pages have been added to the associated website project. In this example, additional pages entitled and/or represented in the navigation bar of the home page as shown in FIG. 7 “Family”, “Sports”, “Games”, and “Travel” have been created and linked to the home page. As shown in this example, as each page was added its title, a short form of its title, and/or some other suitably short name or other identifier for the page has been added to the navigation bar appearing between the horizontal lines just below the title of the home page, simply “Home” in this example. Addition of the page “Family” resulted in the location of and spacing between the names of previously-created pages “Home”, “Photos”, and “Blog” being adjusted automatically to accommodate the additional link to the page “Family”, and addition of the further pages “Sports”, “Games”, and “Travel” caused the navigation bar to be resized automatically, in this example by adding a second row, to accommodate navigation links to these pages. When the page is published, the navigation bar is displayed as it is shown in editing pane 102 and hypertext links to the respective pages are created automatically, enabling a viewer of the published website to navigate the site by selecting the link(s) corresponding to the page(s) the viewer wishes to access.

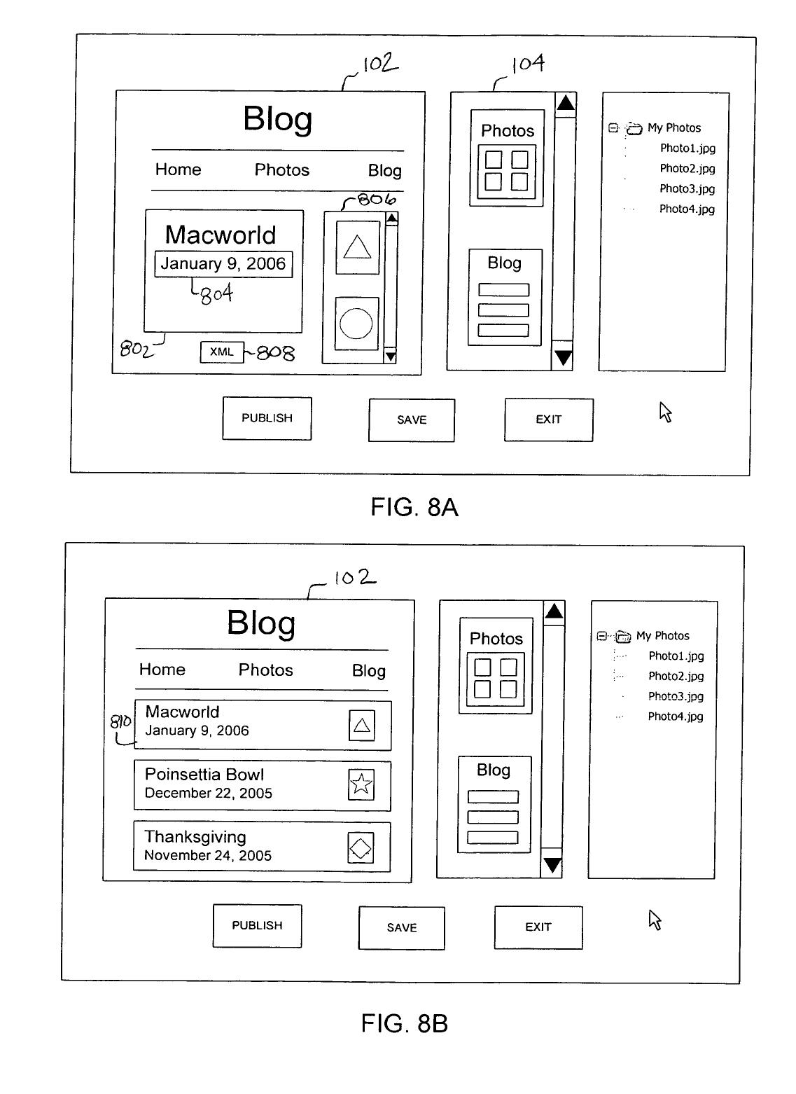

FIGS. 8A and 8B are block diagrams illustrating an embodiment of a user interface for creating/editing a blog page. In the example shown in FIG. 8A, a blog entry page has been created and/or opened for editing in editing pane 102, e.g., by selecting a blog entry page template from template pane 104. In this example, an entry title “Macworld” has been added by the user in an entry text area 802 and a date for the entry has been added automatically in an entry date area 804. In some embodiments, the time of day is included in addition to the date. In the example shown, the template includes a vertically oriented photo grid 806 to which the user has added user images represented in FIG. 8A by the triangle and circle images shown. The page includes automatically, both as displayed to the user in editing pane 102 and as published to the Web, a subscription button 808 that enables a viewer of the page to subscribe, e.g., using an RSS-compliant reader or other program, to the associated blog, e.g., to receive automatically summaries and/or other updates or alerts when new content is added, e.g., when a new blog entry or other syndicated content is posted. In some embodiments, the subscription button 808 appears on an associated blog summary page instead of and/or in addition to an individual blog entry page, as shown in FIG. 8A. Upon receiving an indication that a webpage and/or website/project including one or more blog entries is to be published to the Web, in some embodiments RSS-compliant code is generated to provide subscription functionality and expose such functionality to a viewer of the published webpage(s), e.g., via a subscription link or control such as subscription button 808.

In some embodiments, creation and/or modification of a blog entry page, such as the one shown in FIG. 8A as being displayed in editing pane 102, results in a summary of the entry being generated automatically and included automatically in an associated blog summary/index page, as shown in FIG. 8B. In the example shown, the summary 810 has been generated and added to the blog summary page displayed in editing pane 102 as shown in FIG. 8B. In this example, the summary includes the title, entry date, and a thumbnail of a first or otherwise representative image from the entry, in this case the triangle image shown in photo grid 806 of the blog entry page as shown in FIG. 8A. In some embodiments, a summary of the text of the entry, e.g., the first fifty words or a summary generated using natural language and/or other techniques for automatically generating a summary of textual content, is included automatically. In some embodiments, the automatically generated content can be replaced, modified, or deleted by the user, if desired. In the example shown, the summary 810 for the new blog entry page is integrated into the summary page as shown in FIG. 8B in reverse chronological order, appearing above previously-posted entries entitled “Poinsettia Bowl” and “Thanksgiving”. In this example individual blog entry pages are not listed in the navigation bar appearing under the page title and are instead access via the blog summary page shown in FIG. 8B, e.g., by clicking a link in the corresponding summary.

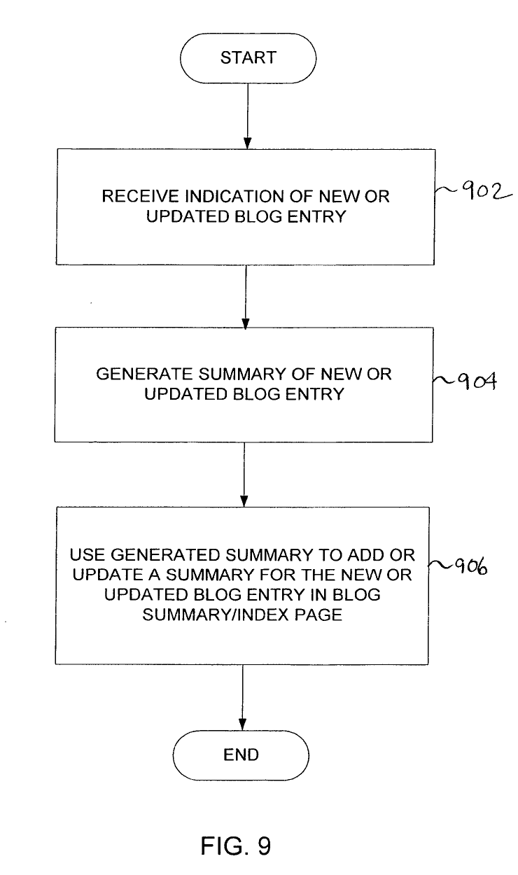

FIG. 9 is a flow chart illustrating an embodiment of a process for enabling a user to create/edit a blog page. At 902, an indication is received that a blog entry page has been created and/or edited. At 904, a summary of the new or updated blog entry page is generated automatically and at 906 the generated summary is incorporated in real time into an associate blog summary page, e.g., by adding to the summary page a summary for the blog entry page and/or updating an existing associated summary. In some embodiments, the process of FIG. 9 is repeated each time a blog entry page is created and/or edited. In various embodiments, the summary for a blog entry is generated and added to (or updated in) an associated blog summary page when the blog entry page is saved, closed, and/or published.

The user interface and techniques described herein enable a user with limited or no knowledge of web page design and layout, including one with limited or no knowledge of html or other languages used to encode webpage content, to create and/or edit and publish to the Web a webpage or multiple pages comprising a website. The use of professionally designed templates, automatic creation/updating of data on related pages, and displaying the page during creation/editing in the manner in which it will/would appear when published facilitate the creation and editing of professional quality pages that have when published the appearance and functionality the user desires.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A method of enabling a user to create and/or edit a webpage, comprising:
receiving a selection of a selected template from a set of one or more webpage templates selectable by a user to create and open for editing an instance of a webpage;
creating an instance of a webpage based at least in part on the selected template;
displaying in an editing interface a representation of the webpage that shows the webpage as it would appear as published; and
updating the representation of the webpage in real time in response to changes, if any, made to the webpage, so that as changes, if any, are made to the webpage the representation is updated to show the webpage as it would appear as published with the changes incorporated.

2. A method as recited in claim 1, further comprising displaying the set of one or more webpage templates.

3. A method as recited in claim 1, wherein the set of one or more webpage templates includes one or more of the following: a home page template, a photo page template, a blog summary template, a blog entry template, a photo grid template, a template with a background but no other content items, and a blank template.

4. A method as recited in claim 1, wherein the set of one or more webpage templates includes one or more templates having one or more of the following features: a default set of content, a default content item, a default media content item, a placeholder image, and a placeholder text.

5. A method as recited in claim 1, wherein the editing interface enables a user to perform one or more of the following operations with respect to the webpage: add a content item, modify a content item, and create content.

6. A method as recited in claim 1, wherein the editing interface enables a user to add a content item to the webpage by dropping, pasting, or otherwise locating the content item or a copy thereof in the representation of the webpage as displayed via the editing interface.

7. A method as recited in claim 1, further comprising receiving an indication that the webpage is to be published.

8. A method as recited in claim 1, further comprising publishing the webpage to the Web.

9. A method as recited in claim 1, further comprising automatically generating code as required to publish the webpage.

10. A method as recited in claim 1, further comprising automatically generating code as required to provide to a viewer of the webpage as published any webpage functionality associated with the webpage as created and edited by a user via the editing interface.

11. A method as recited in claim 1, wherein the webpage comprises a blog entry.

12. A method as recited in claim 1, wherein the webpage comprises a blog entry and the method further comprises generating automatically for the blog entry an entry summary and adding the summary to a blog summary page.

13. A method as recited in claim 12, wherein generating automatically for the blog entry an entry summary includes identifying in the blog entry and including in the summary one or more of the following: an entry title, an entry date, a posting time, a representative image, a thumbnail image, a prescribed number of words, and a summary created using natural language or other text summary generation techniques.

14. A method as recited in claim 12, further comprising updating the entry summary as included in the blog summary page in response to reflect a change to the blog entry.

15. A method as recited in claim 1, wherein the webpage comprises a blog entry and the method further comprises generating automatically for at least one of the blog entry and a blog summary page associated with the entry a subscription icon selectable to subscribe to syndicated content associated with a blog with which the blog entry is associated.

16. A method as recited in claim 1, wherein the selected template includes a photo grid and the method further comprises automatically resizing the photo grid, if required, to accommodate one or more additional images added to the photo grid.

17. A method as recited in claim 1, wherein the selected template includes a photo grid and the method further comprises automatically rearranging one or more images within the photo grid, if required, to accommodate one or more additional images added to the photo grid.

18. A method as recited in claim 1, wherein the editing interface enables a user to navigate in a navigation pane to a user file containing a content item accessible via a host via which the editing interface is being presented to the user and add the content item to the webpage by dragging a representation of the user file from the navigation pane to the webpage as displayed in the editing interface.

19. A method as recited in claim 1, wherein the webpage is associated with one or more other webpages and the selected template is configured to include in the webpage automatically a navigation bar in which a link to one or more of the one or more other webpages is provided.

20. A method as recited in claim 19, further comprising automatically resizing the navigation bar, if required, to accommodate one or more additional webpage pages added to the one or more other webpages with which the webpage is associated.

21. A system for enabling a user to create and/or edit a webpage, comprising:
a display; and
a processor coupled to the display and configured to:
receive a selection of a selected template from a set of one or more webpage templates selectable by a user to create and open for editing an instance of a webpage;
create an instance of a webpage based at least in part on the selected template;
provide in an editing interface presented via the display a representation of the webpage that shows the webpage as it would appear as published; and
update the representation of the webpage in real time in response to changes, if any, made to the webpage, so that as changes, if any, are made to the webpage the representation is updated to show the webpage as it would appear as published with the changes incorporated.

22. A computer program product for enabling a user to create and/or edit a webpage, the computer program product being embodied in a computer readable medium and comprising computer instructions for:
receiving a selection of a selected template from a set of one or more webpage templates selectable by a user to create and open for editing an instance of a webpage;
creating an instance of a webpage based at least in part on the selected template;
displaying in an editing interface a representation of the webpage that shows the webpage as it would appear as published; and
updating the representation of the webpage in real time in response to changes, if any, made to the webpage, so that as changes, if any, are made to the webpage the representation is updated to show the webpage as it would appear as published with the changes incorporated.
